(19) United States
(12) Patent Application Publication
(10) Pub. No.: US 2007/0163837 A1
(43) Pub. Date: Jul. 19, 2007

(54) Tool support

(76) Inventor: August Dale Dyer, Elmhurst, IL (US)

Correspondence Address: SEYFARTH SHAW LLP, 131 S. DEARBORN ST., SUITE2400, CHICAGO, IL, 60603-5803, US

(21) Appl. No.: 11/335,410

(22) Filed: Jan. 19, 2006

(51) Int. Cl. E06C 5/32

(52) U.S. Cl. 182/129

(57) ABSTRACT

A tool support attachable to a frame of a support structure as a ladder. The tool support includes a base removably connected to the frame. The base includes a resilient portion which is biased inwardly towards the frame to secure the base at a designated position on the frame. An interchangeable attachment is removably connected to the base, where the attachment is adapted to hold at least one tool.

### BACKGROUND

Tools are used for a variety of purposes from household repairs to construction projects. In most instances, more than one tool is needed for these projects. Carrying a bulky toolbox or wearing a tool belt can be cumbersome and a safety hazard especially on projects in higher places where climbing a ladder or scaffolding is required. In these situations, carrying a bunch of tools can prevent hands from being free to hold onto a ladder or cause tools to drop below creating another safety hazard.

As a result, certain equipment such as ladders have been manufactured with shelves and other type of supports to enable tools to be safely placed and held on a ladder thereby freeing a user's hands to hold the ladder and the tool being used. Such supports typically include pivoting shelves which include one or more holes for holding tools such as screwdrivers, hammers and the like. These supports, however, are typically secured at a particular position on the ladder such as near the top of the ladder and are not adjustable so as to be raised or lowered if necessary. Furthermore, these shelves and supports typically only have certain sized holes to accommodate tools of a certain size or shape.

Accordingly, there is a need for an interchangeable tool support that is connectable to ladders, adjustable to accommodate projects at different levels on the ladder and able to receive and secure tools of different sizes and shapes.

### SUMMARY

The present invention is directed to a tool support and more specifically, to a tool support attachable to a support structure which enables a user to secure different types of tools at any position on the support structure.

One embodiment provides a tool support attachable to a frame of a support structure. The tool support includes a base removably connected to the frame of the support structure. The base includes a resilient portion which is biased inwardly towards the frame to secure the base at a designated position on the frame. An interchangeable attachment is removably connected to the base, where the attachment is adapted to hold at least one tool.

In an embodiment, the base includes at least one rib adapted to grip the frame.

In an embodiment, the base includes a plurality of ribs, where each of the ribs is adapted to grip the frame.

In am embodiment, the base defines at least two openings and the attachment includes at least two posts adapted to respectively engage the openings.

In an embodiment, at least one of the openings is a different size from the other of the openings.

In an embodiment, the attachment defines at least one opening adapted to receive the tool.

In an embodiment, the attachment defines a plurality of openings, where each of the openings is adapted to receive the tool.

In an embodiment, the attachment includes at least one hook adapted to hold the tool.

Another embodiment provides a tool support attachable to a frame of a ladder. The tool support includes a base having at least two bias members and defining at least one opening. The base is connected to the frame to engage the base and the bias members with the frame. Each of the bias members are biased substantially inwardly toward the frame to secure the base at a designated position on the frame. An interchangeable attachment is removably connected to the opening defined by the base. The attachment is adapted to hold at least one tool.

In an embodiment, the base includes at least one rib adapted to grip the frame.

In an embodiment, the base includes a plurality of ribs, each of the ribs adapted to grip the frame.

In an embodiment, the attachment includes a post adapted to engage the opening defined by the base.

In an embodiment, the base defining a plurality of openings.

In an embodiment, at least one of the openings is a different size from the other of the openings.

In an embodiment, the attachment defines at least one opening adapted to receive the tool.

In an embodiment, the attachment defines a plurality of openings, each of the openings adapted to receive the tool.

In an embodiment, the attachment includes at least one hook adapted to receive the tool.

It is therefore an advantage to provide a tool support that is connectable to a ladder at different positions on the ladder.

It is another advantage to provide a tool support having an interchangeable attachment for securing several different types of tools.

Other objects, features and advantages of the invention will be apparent from the following detailed disclosure, taken in conjunction with the accompanying sheets of drawings, wherein like numerals refer to like parts, elements, components, steps and processes.

### DESCRIPTION OF THE FIGURES

FIG. 1 is a left side perspective view of different embodiments of the tool support attached to different positions on a frame of a ladder.

FIG. 2 is a right side perspective view of the embodiments of the tool support of FIG. 1.

FIG. 3A is a front perspective view of one embodiment of a base of the tool support.

FIG. 3B is a left side view of the base of FIG. 3A.

FIG. 3C is a top view of the base of FIG. 3A.

FIG. 3D is a rear view of the base of FIG. 3A.

FIG. 3E is a bottom view of the base of FIG. 3A.

FIG. 3F is a rear perspective view of the base of FIG. 3A.

FIG. 3G is a right side view of the base of FIG. 3A.

FIG. 4A is a front perspective view of one embodiment of an attachment connectable to the base of the tool support.

FIG. 4B is a left side view of the attachment of FIG. 4A.

FIG. 4C is a top view of the attachment of FIG. 4A.

FIG. 4D is a front view of the attachment of FIG. 4A.

FIG. 4E is a bottom view of the attachment of FIG. 4A.

FIG. 4F is a rear perspective view of the attachment of FIG. 4A.

FIG. 4G is a right side view of the attachment of FIG. 4A.

FIG. 5A is a front perspective view of another embodiment of an attachment connectable to the base of the tool support.

FIG. 5B is a left side view of the attachment of FIG. 5A.

FIG. 5C is a top view of the attachment of FIG. 5A.

FIG. 5D is a front view of the attachment of FIG. 5A.

FIG. 5E is a bottom view of the attachment of FIG. 5A.

FIG. 5F is a rear perspective view of the attachment of FIG. 5A.

FIG. 5G is a right side view of the attachment of FIG. 5A.

FIG. 6A is a front perspective view of another embodiment of an attachment connectable to the base of the tool support where the attachment includes two hooks.

FIG. 6B is a top view of the attachment of FIG. 6A.

FIG. 6C is a left side view of the attachment of FIG. 6A.

FIG. 6D is a front view of the attachment of FIG. 6A.

FIG. 6E is a bottom view of the attachment of FIG. 6A.

FIG. 6F is a rear perspective view of the attachment of FIG. 6A.

FIG. 6G is a right side view of the attachment of FIG. 6A.

### DETAILED DESCRIPTION

The present invention is directed to a tool support and more specifically, to a tool support attachable to a support structure to secure one or more tools at different positions on the support structure.

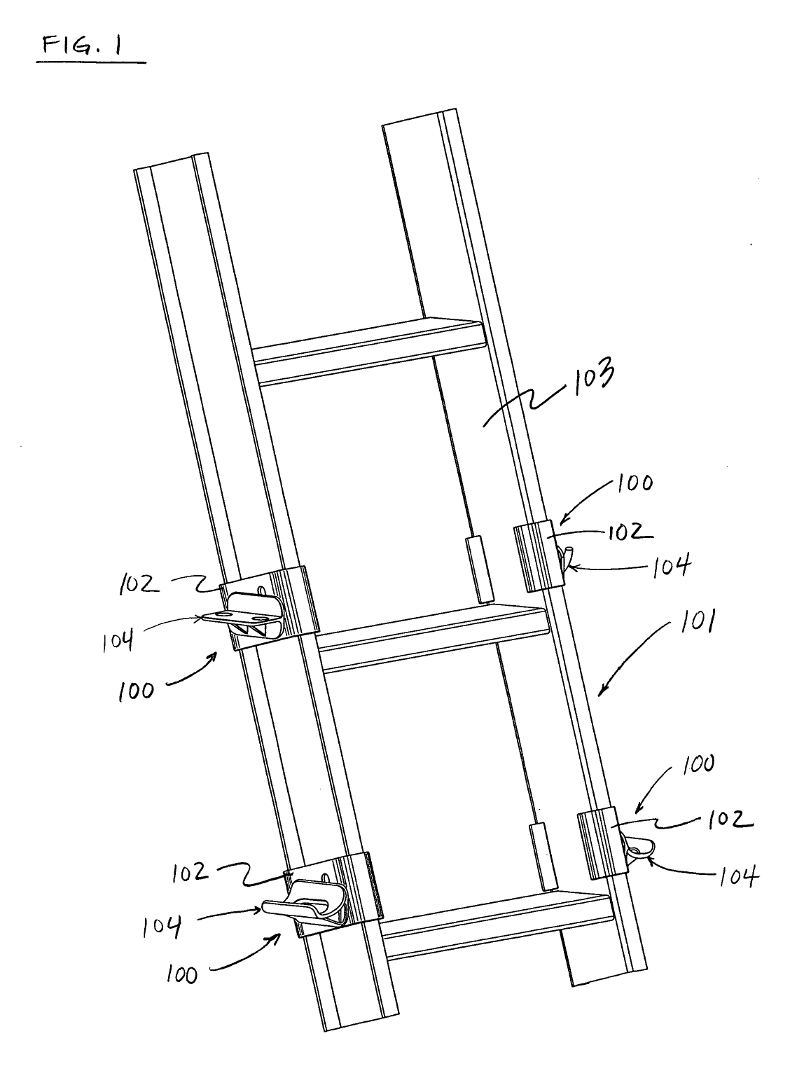

Referring to the figures, one embodiment of the tool support of the present invention is illustrated where the tool support 100 is attached to a support structure such as ladder 101. The tool support includes a base 102 and an attachment 104 which is removably connected to the base. The attachment 104 is interchangeable and is adapted to hold or secure one or more different types of tools as described below. As shown in FIGS. 1 and 2, one or more tool supports 100 may be connected to a ladder or similar support structure to hold or secure one or more tools on a frame 103 of the ladder. The tool supports 101 can be secured to the frame 103 at different positions on the frame.

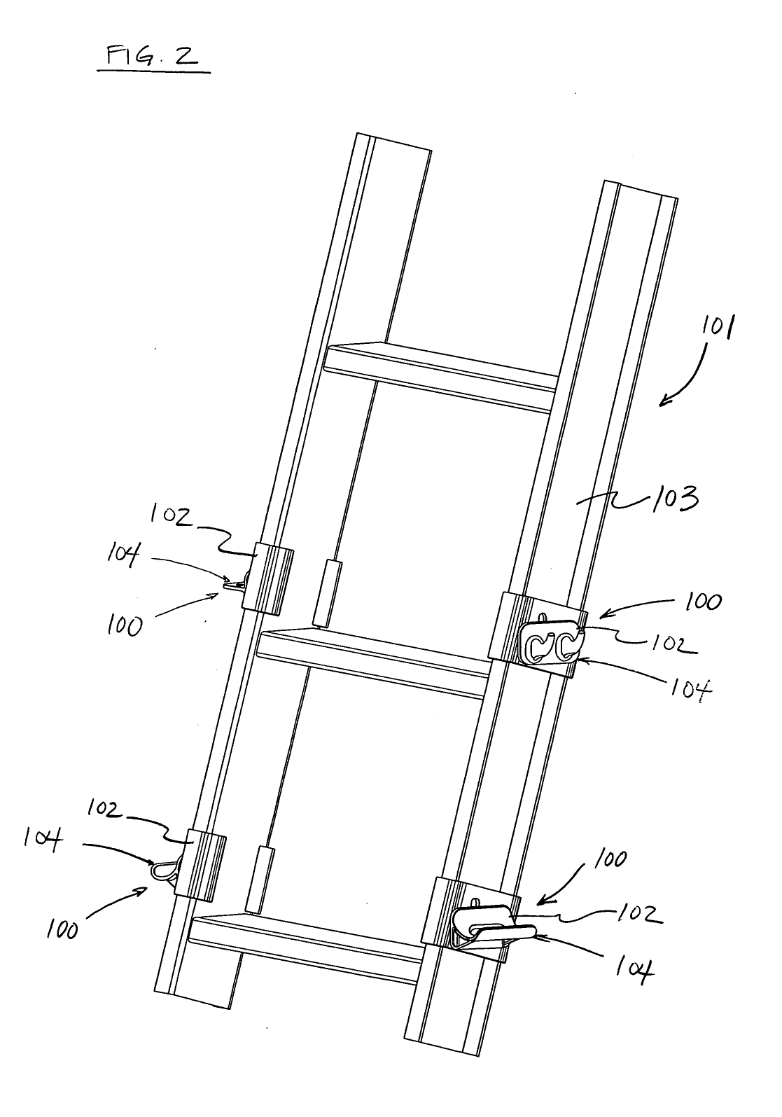

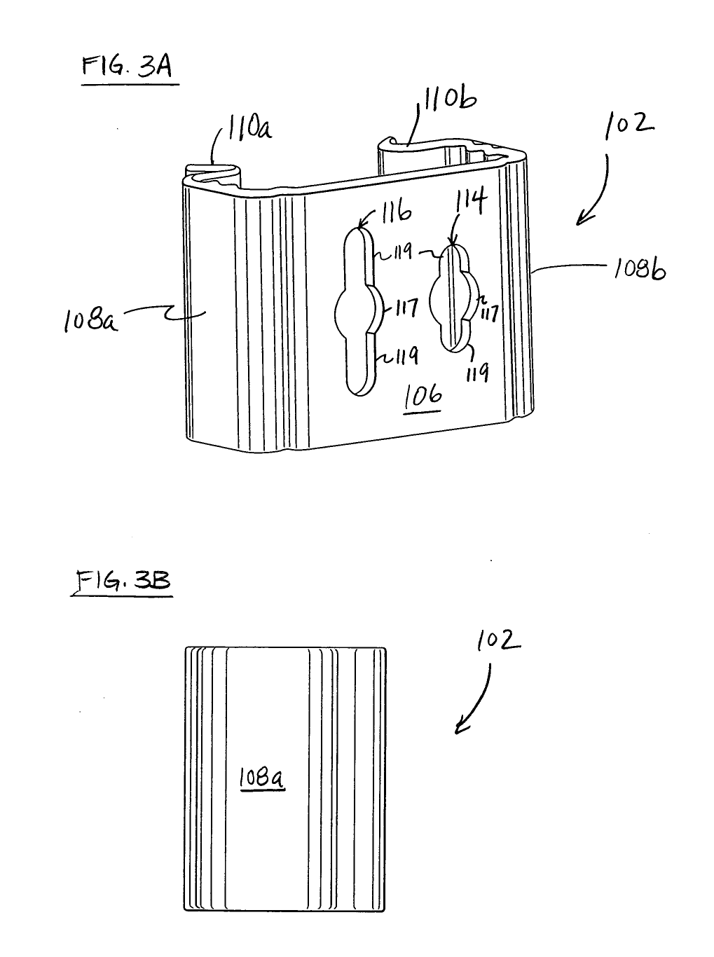

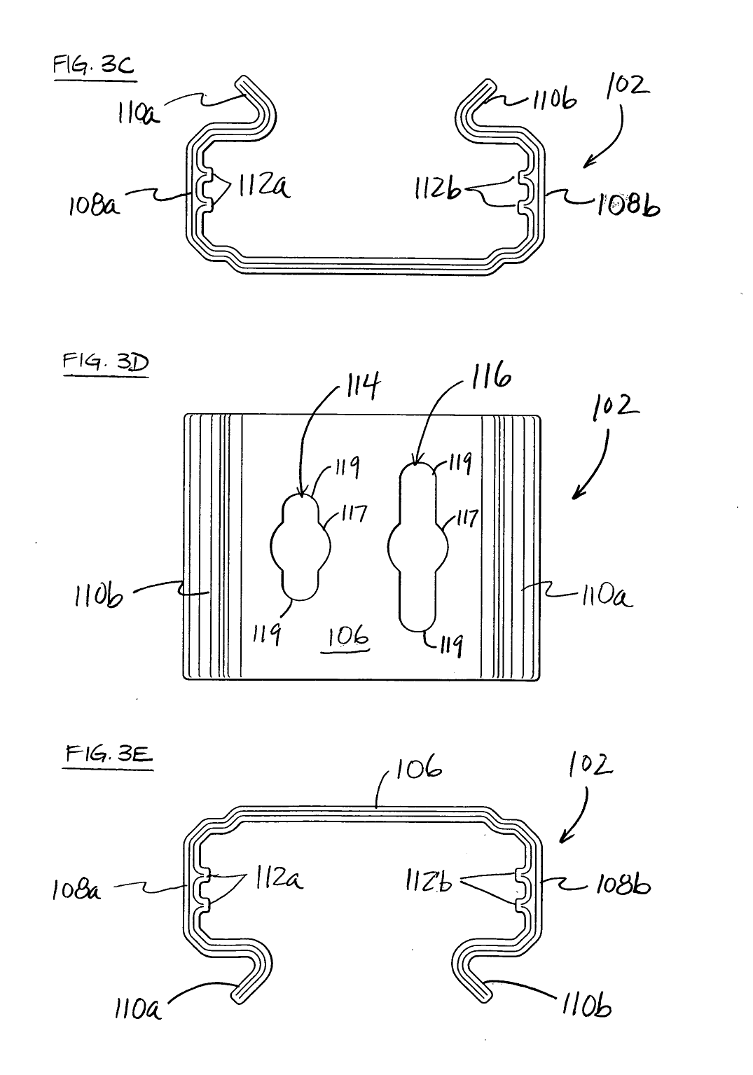

Referring to FIGS. 3A to 3G, the base 102 includes a front wall 106 integrally formed with side walls 108a and 108b. The ends of each of the sidewalls 108a and 108b define opposing bias members or legs 110a and 110b, respectively. The bias members 110a and 110b are inwardly biased toward the frame 103. Therefore when the base 102 is attached to the frame 103, the side walls 108a and 108b fit around the frame of the ladder and the bias members 110a and 110b are biased inwardly toward the frame to securely hold the base 102 on the frame. The inwardly biased bias members 110a and 110b therefore maintain the position of the tool support on the frame of the ladder. To remove the tool support 100 from the frame 103, a user applies an outward force on each of the bias members 110a and 110b to move the bias members outwardly away from each other and the frame 103 to disengage the base 102 from the frame 103.

In the illustrated embodiment, each of the side walls 108a and 108b include at least one or more protrusions or ribs 112a and 112b. The ribs 112a and 112b contact or engage the frame 103 to facilitate the gripping of the base 102 to the frame. This helps to maintain or secure the position of the tool support 100 on the frame 103 of the ladder.

In an embodiment, the front wall 106 of the base 102 defines a plurality of openings 114 and 116. Each of the openings 114 and 116 include a round middle portion 117 and elongated opposing end portions 119. It should be appreciated that the openings may be any suitable size or shape. As shown at FIG. 3A, the opening 114 is relatively smaller than the opening 116. It should be appreciated that any suitable number of openings may be defined by the base. It should also be appreciated that the openings may be the same size or different sizes.

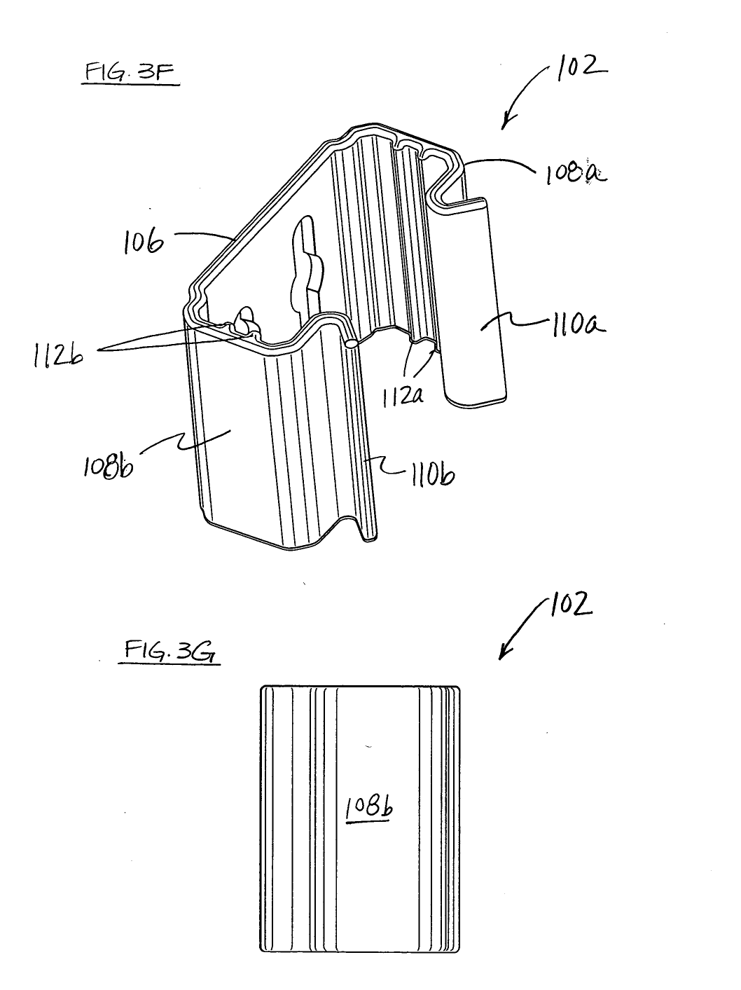

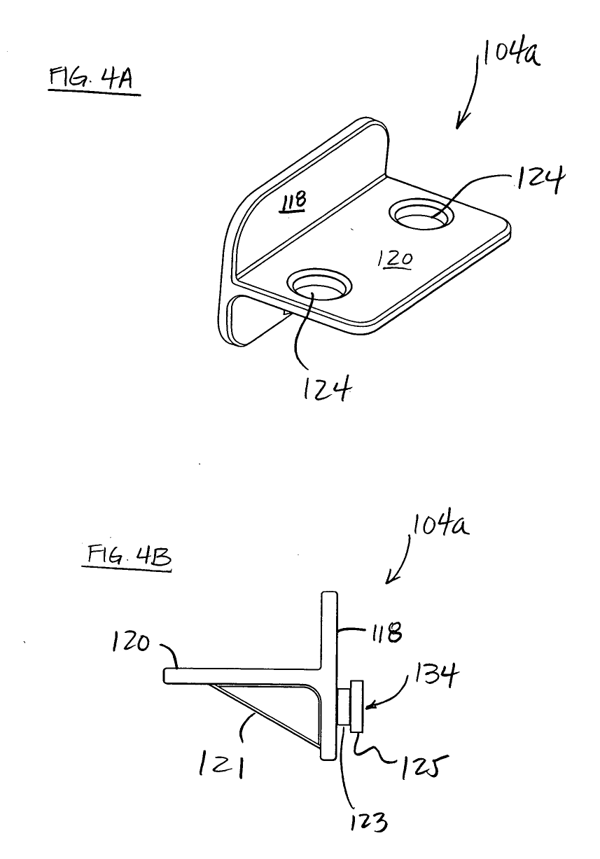

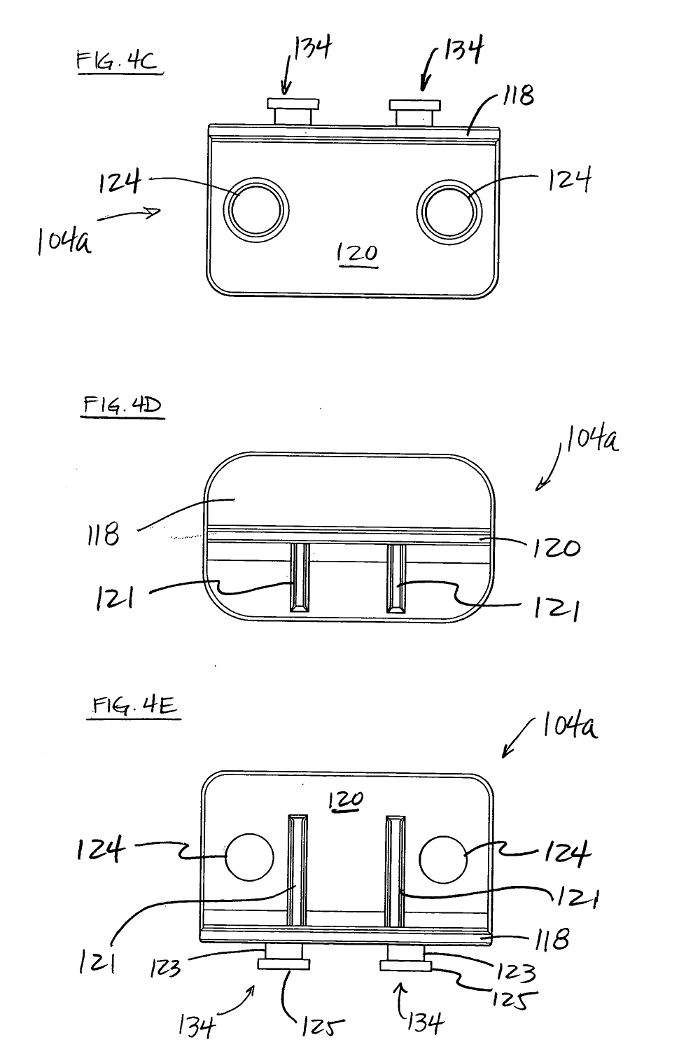

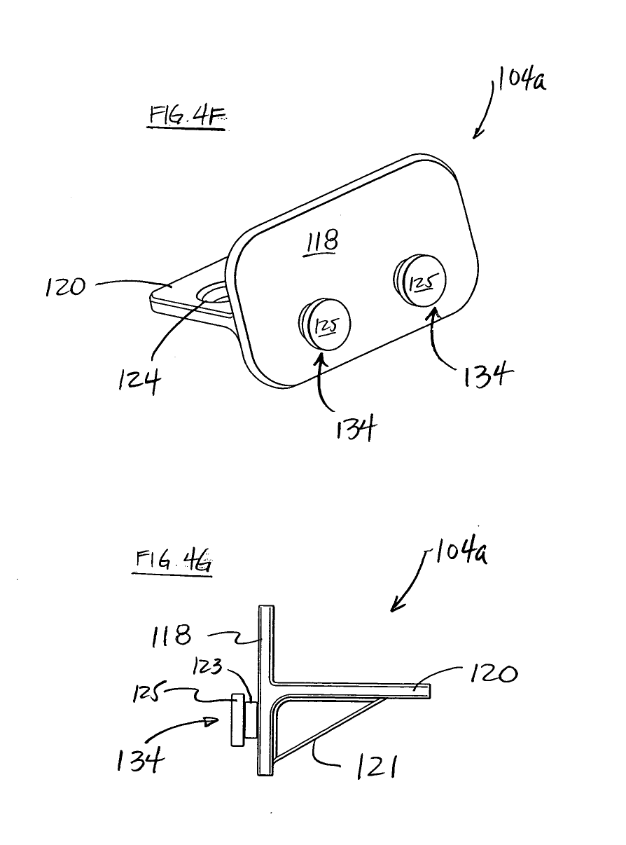

Referring now to FIGS. 4A to 4G, one embodiment of an interchangeable attachment is illustrated where the attachment 104a is configured to secure, hold or support one or more tools. For example, a screwdriver or other similar tool can be held or secured by attachment 104. In this embodiment, attachment 104 includes a base wall 118 and a flange or shelf 120 integrally formed with the base wall. The flange 120 defines two openings 124. The openings 124 are configured to receive and secure at least one tool. It should be appreciated that the flange 120 may define one, two, three or more openings. In the illustrated embodiment, the openings 124 are the same size and are adapted to receive a tool. It should be appreciated that the flange may define one or more openings where one, a plurality or all of the openings are the same or different sizes. It should also be appreciated that the opening may be circular, oblong, square or any suitable size or shape.

As shown in FIGS. 4B and 4G, the attachment 104 includes supports or brackets 121 which are connected at one end to the base wall 118 and to the bottom surface of the flange 120 at an opposite end. It should be appreciated that the brackets 121 may be connected to or integrally formed with the base wall and the flange. It should also be appreciated that the attachment 104 may include one or more brackets as necessary to support the flange 120.

The attachment 104 includes connecting posts 134 which are each transverse to the base wall 118 and extend outwardly from the base wall. Each of the posts includes a shaft 123 connected to the base wall 118 and a head 125 which is integrally formed with the shaft. The posts 134 and more specifically the head 125 and shaft are sized and shaped to be inserted into the round middle portions 117 of openings 114 and 116 and moved or slid downwardly into the end portions 119 of the openings to secure the attachment 104 to the base 102. The end portions 119 of openings 114 to 116 are different lengths to enable the attachment 104 to be secured to the base 102 in a substantially horizontal position as shown in FIGS. 1 and 2. It should be appreciated that the lengths of end portions 119 may be any suitable length.

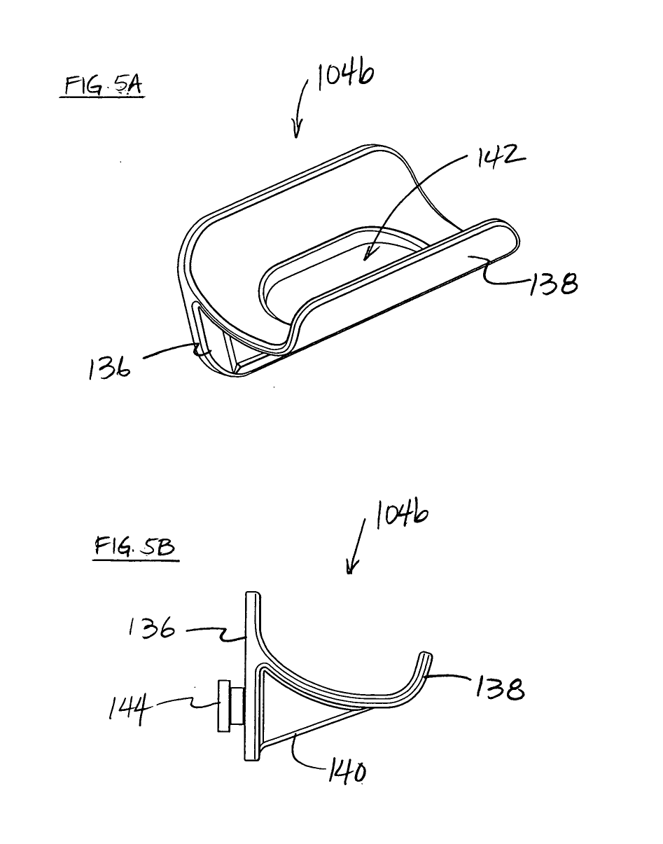

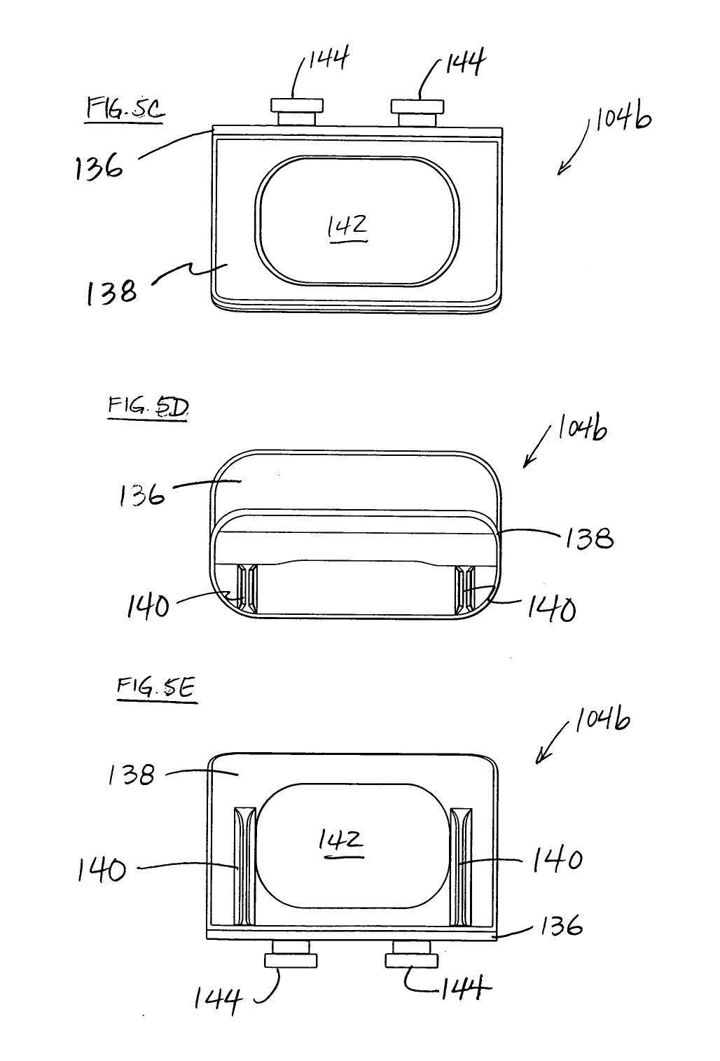

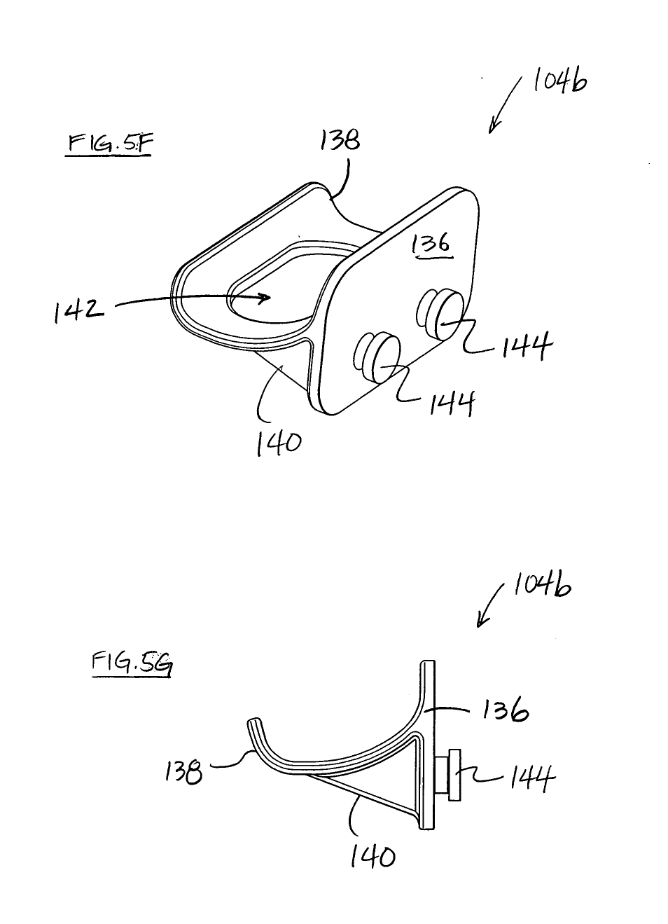

Referring to FIGS. 5A to 5G, another embodiment of the attachment is illustrated where the attachment 104b defines a relatively large opening for holding or securing a larger tool such as a hammer or several smaller sized tools. In the illustrated embodiment, attachment 104b includes a base wall 136 and a flange 138 which is transverse to an integrally formed with the base wall. The flange 138 is supported by two brackets 140 which are connected at one end to the flange 138 and at an opposing end to the base wall 136. As described above, the brackets 140 help support the flange 138 and the weight of any tools held or secured by the flange. The flange 138 defines an opening 142. The opening 142 has a generally oval shape. It should be appreciated that the opening 142 may be any suitable size and shape. In the illustrated embodiment, the flange 138 has a generally curved shape or concave shape to better fit the shape of a tool or tools secured in the flange. It should be appreciated that the flange 138 may have any suitable shape or configuration. Similar to attachment 104a, attachment 104b is connected to or secured to the base 102 by inserting posts 144 into corresponding openings 114,116 defined by the base 102 as described above.

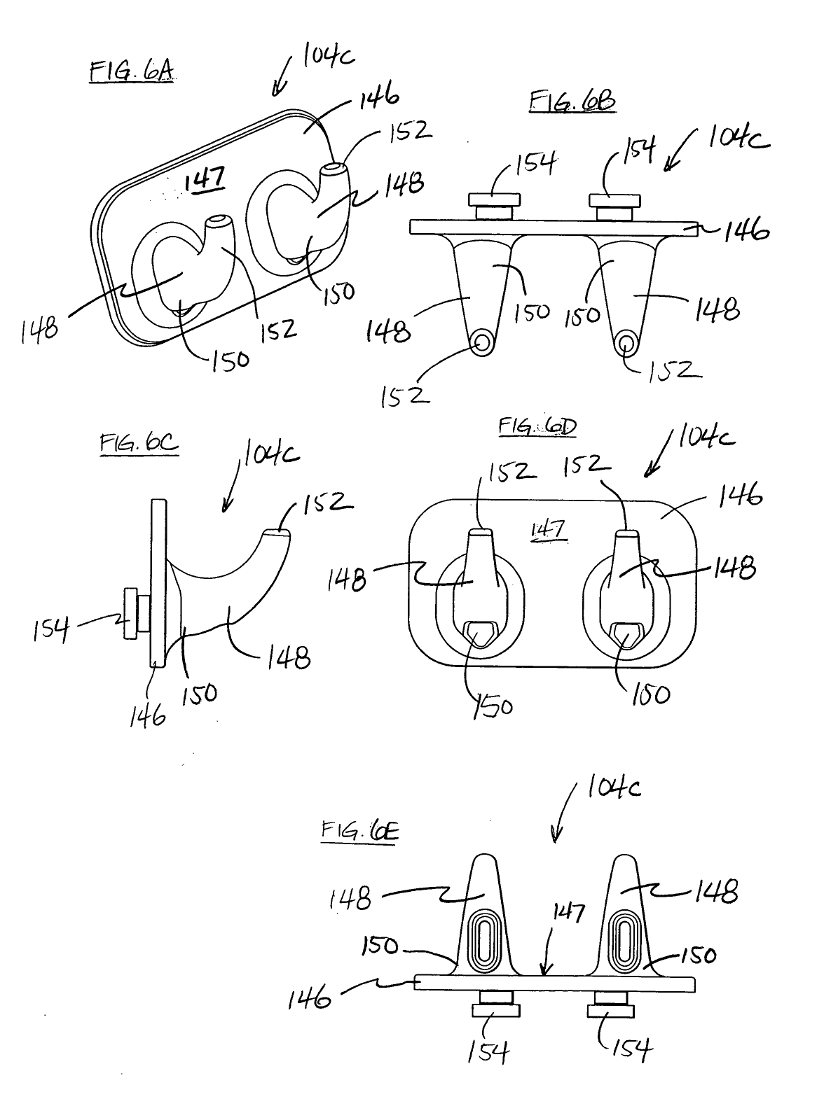

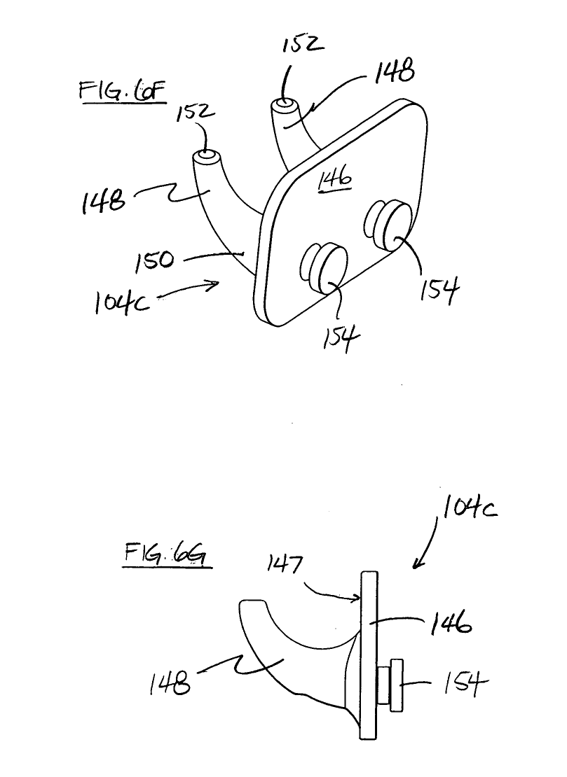

Referring now to FIGS. 6A to 6G, another embodiment of the attachment is illustrated where the attachment 104c has a substantially planar base wall 146 and a pair of hooks 148 connected to a surface of the base wall. Each of the hooks 148 is connected to the surface of the base wall at one end 150 and have an opposing end 152 which extends outwardly and upwardly from the base wall 146. It should be appreciated that one, a plurality or all of the hooks 148 may be curved or angled at the same angle or curvature or at different angles or curvatures. In the illustrated embodiment, the hooks 148 are spaced apart a designated distance. A tool such as a hammer (not shown) is placed or seated on the hooks 148 to hold or secure the hammer on the attachment. Alternatively, one or more tools having openings such as a hand saw having a handle that defines an opening, can be placed over one or both hooks to hold or secure the tool to the attachment 104c. It should be appreciated that the attachment 104c may include one or a plurality of the hooks 148. Attachment 104c is secured to base 102 by inserting posts 154 into openings 114 and 116, respectively, as described above.

It should be appreciated that any suitable attachment or attachments may be employed with the tool support 100 and connected to the base 102 to support one or more tools.

In the above embodiments, the base and attachments are made of a durable material such as a durable plastic. It should be appreciated the any suitable material or materials may be used to manufacture the base, the attachments and the other parts of the tool support.

Additionally, the tool support of the above embodiments is shown as being attached to a ladder. It should be appreciated that the tool support may be configured to attach to a ladder, scaffolding or any other suitable support structure.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A tool support attachable to a frame of a support structure, the tool support comprising:
a base removably connected to the frame of the support structure, the base including a resilient portion which is biased inwardly towards the frame to secure the base at a designated position on the frame; and
an interchangeable attachment removably connected to the base, the attachment adapted to hold at least one tool.

2. The tool support of claim 1, wherein the base includes at least one rib adapted to grip the frame.

3. The tool support of claim 1, wherein the base includes a plurality of ribs, each of the ribs adapted to grip the frame.

4. The tool support of claim 1, wherein the base defines at least two openings and the attachment includes at least two posts adapted to respectively engage the openings.

5. The tool support of claim 4, wherein at least one of the openings is a different size from the other of the openings.

6. The tool support of claim 1, wherein the attachment defines at least one opening adapted to receive the tool.

7. The tool support of claim 1, wherein the attachment defines a plurality of openings, each of the openings adapted to receive the tool.

8. The tool support of claim 1, wherein the attachment includes at least one hook adapted to hold the tool.

9. A tool support attachable to a frame of a ladder, the tool support comprising:
a base having at least two bias members and defining at least one opening, the base is connected to the frame to engage the base and the bias members with the frame, each of the bias members biased substantially inwardly toward the frame to secure the base at a designated position on the frame; and
an interchangeable attachment removably connected to the opening defined by the base, the attachment adapted to hold at least one tool.

10. The tool support of claim 9, wherein the base includes at least one rib adapted to grip the frame.

11. The tool support of claim 9, wherein the base includes a plurality of ribs, each of the ribs adapted to grip the frame.

12. The tool support of claim 11, wherein the attachment includes a post adapted to engage the opening defined by the base.

13. The tool support of claim 11, the base defining a plurality of openings.

14. The tool support of claim 13, wherein at least one of the openings is a different size from the other of the openings.

15. The tool support of claim 11, wherein the attachment defines at least one opening adapted to receive the tool.

16. The tool support of claim 11, wherein the attachment defines a plurality of openings, each of the openings adapted to receive the tool.

17. The tool support of claim 11, wherein the attachment includes at least one hook adapted to receive the tool.
